(19) United States
(12) Patent Application Publication
(10) Pub. No.: US 2012/0033125 A1
(43) Pub. Date: Feb. 9, 2012

(54) IMAGING OPTICAL DEVICE

(76) Inventors: NAI-YUAN TANG, Tainan (TW); Chuan-Hui Yang, Tainan (TW)

(21) Appl. No.: 12/851,196

(22) Filed: Aug. 5, 2010

(51) Int. Cl. H04N 5/225; G02B 9/62

(52) U.S. Cl. 348/340; 359/757; 348/E05.024

(57) ABSTRACT

An imaging optical device includes a first lens group and a second lens group disposed in an order from the object side to the image side. The first lens group has a positive refractive power, and includes at least a first lens, a second lens and a third lens in an order from an object side to an image side. The third lens has a convex image-side surface. The second group has a negative refractive power and includes at least three lenses.

### BACKGROUND OF THE INVENTION

1. Field of the Invention

The present invention generally relates to a miniaturized imaging optical device, and more particularly to a wafer-level photographic lens.

2. Description of Related Art

Wafer level optics is a technique of fabricating miniaturized optics such as lens module or camera module at the wafer level using semiconductor techniques. The wafer level optics is well adapted to mobile or handheld devices, to which photograph has become an indispensable function.

As the size of an image sensor, such as a charge-coupled devices (CCD) or a complementary metal-oxide-semiconductor image sensor (CIS), is scaled down, the photographic lens need be scaled down too.

Imaging lens design is a stringent process to achieve requirements such as low volume, light weight, low cost but high resolution. A general-purpose camera, either stand-alone or integrated with a handheld device such as a mobile phone, commonly uses two groups of imaging lenses in order to meet the high resolution demand. Each group includes two or more lenses that integrally accomplish required optical characteristics, and the two groups should also work together to achieve high performance.

Therefore, there is a need for a designer to propose a novel imaging optical device, particularly a wafer-level miniaturized optical device that has high image quality with low volume and light weight.

### SUMMARY OF THE INVENTION

In view of the foregoing, it is an object of the embodiment of the present invention to provide an imaging optical device with high resolution and excellent optical characteristics suitable for modern handheld electronic devices.

According to one embodiment, the imaging optical device includes a first lens group and the second lens group disposed in an order from the object side to the image side. The first lens group has a positive refractive power, and includes at least a first lens, a second lens and a third lens in an order from an object side to an image side. Specifically, the first lens has an image-side surface in substantially contact with an object-side surface of the second lens, the second lens has an image-side surface in substantially contact with an object-side surface of the third lens, and the third lens has a convex image-side surface. The second lens group has a negative refractive power, and includes at least a fourth lens, a fifth lens and a sixth lens in an order from the object side to the image side. Specifically, the fourth lens has an image-side surface in substantially contact with an object-side surface of the fifth lens, and the fifth lens has an image-side surface in substantially contact with an object-side surface of the sixth lens.

### BRIEF DESCRIPTION OF THE DRAWINGS

FIG. 1 shows a lens arrangement of a wafer-level imaging optical device according to a first embodiment of the present invention;

FIG. 2A and FIG. 2B show some performances of the imaging optical device according to the first embodiment;

FIG. 3 shows a lens arrangement of a wafer-level imaging optical device according to a second embodiment of the present invention; and

FIG. 4A and FIG. 4B show some performances of the imaging optical device according to the second embodiment.

### DETAILED DESCRIPTION OF THE INVENTION

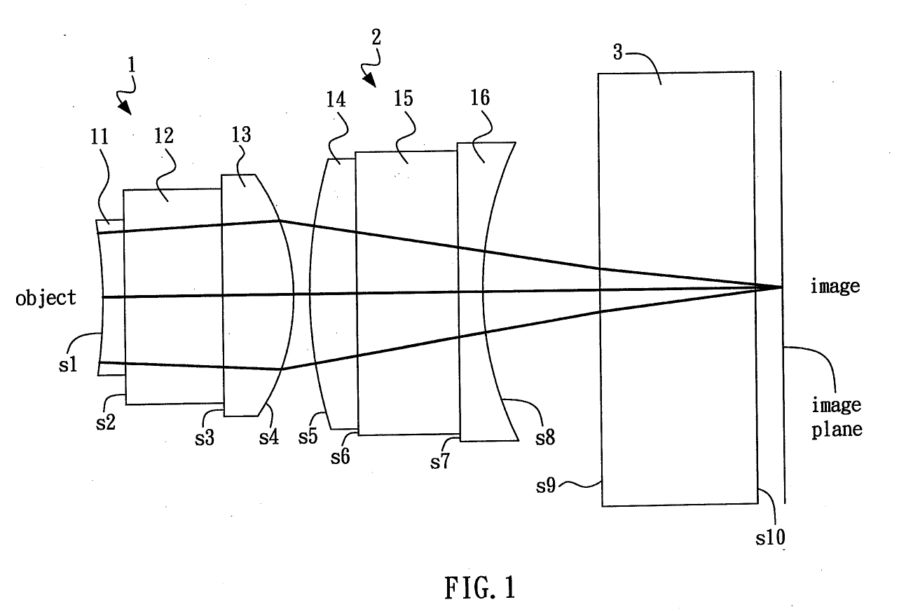

FIG. 1 shows a lens arrangement of a wafer-level imaging optical device according to a first embodiment of the present invention. Although the optical devices of the following illustrated embodiments are fabricated by wafer level technique, it is appreciated by those skilled in the pertinent art that the embodiments may be generally adapted to a miniature optical device fabricated by either the wafer level technique or other fabrication techniques. According to present technology advancement, lens form of the wafer-level optics may be less than 1 μm.

In the drawing, the left side of the imaging optical device faces an object, and the right side of the imaging optical device faces an image (or an image plane). In the first embodiment, the imaging optical device includes two lens groups: a first lens group 1 and a second lens group 2 in the order from the object side to the image side. The first lens group 1 acts as a positive lens having a positive refractive power, and the second lens group 2 acts as a negative lens having a negative refractive power. Specifically, the first lens group 1 includes at least three lenses: a first lens 11, a second lens 12 and a third lens 13 in the order from the object side to the image side. The first lens 11 has a concave object-side surface s1. The first lens 11 has an image-side surface s2 in substantially contact with an object-side surface s2 of the second lens 12. The second lens 12 has an image-side surface s3 in substantially contact with an object-side surface s3 of the third lens 13. The third lens 13 has a convex image-side surface s4. In the exemplary embodiment, the surface s2 (i.e., the image-side surface of the first lens 11 and the object-side surface of the second lens 12) may, but not limited to, be planar. The surface s3 (i.e., the image-side surface of the second lens 12 and the object-side surface of the third lens 13) may, but not limited to, be planar.

The second lens group 2 includes at least three lenses: a fourth lens 14, a fifth lens 15 and a sixth lens 16 in the order from the object side to the image side. The fourth lens 14 has a convex object-side surface s5. The fourth lens 14 has an image-side surface s6 in substantially contact with an object-side surface s6 of the fifth lens 15. The fifth lens 15 has an image-side surface s7 in substantially contact with an object-side surface s7 of the sixth lens 16. The sixth lens 16 has a concave image-side surface s8. In the exemplary embodiment, the surface s6 (i.e., the image-side surface of the fourth lens 14 and the object-side surface of the fifth lens 15) may, but not limited to, be planar. The surface s7 (i.e., the image-side surface of the fifth lens 15 and the object-side surface of the sixth lens 16) may, but not limited to, be planar.

The imaging optical device may optionally include a cover glass 3 for an image sensor such as a charge-coupled device (CCD) or complementary metal-oxide-semiconductor image sensor (CIS). The cover glass 3 has, for example, a planar object-side surface s9 and a planar image-side surface s10.

According to one aspect of the present embodiment, with respect to each lens group 1 or 2, the refraction index of material of at least one lens is substantively different from the refraction index of material of other lens in the same lens group.

Table 1 shows some surface data according to the first embodiment, where the thickness and the radius may be unitless or in the unit, for example, of millimeter (mm).

TABLE 1

| | | | Material |
|---|---|---|---|
| | | | nd: refraction index |
| Surface | Radius | Thickness | νd: dispersion index |
| s1 | −5.128 | 0.0563 | nd = 1.52, νd = 50 |
| s2 | Infinity | 0.2567 | nd = 1.51, νd = 70 |
| s3 | Infinity | 0.1815 | nd = 1.52, νd = 50 |
| s4 | −0.513 | 0.0428 | |
| s5 | 1.471 | 0.1155 | nd = 1.52, νd = 50 |
| s6 | Infinity | 0.2567 | nd = 1.51, νd = 70 |
| s7 | Infinity | 0.0599 | nd = 1.52, νd = 50 |
| s8 | 1.071 | 0.3 | |
| s9 | Infinity | 0.4 | nd = 1.5168, νd = 64.17 |
| s10 | Infinity | 0.061 | |

Table 2 shows some optical data according to the first embodiment.

TABLE 2

| | |
|---|---|
| F number (focal ratio) | 2.8 |
| Effective focal length | 1 |
| Field of view (FOV) | 60 degree |
| Effective focal length of first lens group | 1.05 |
| Effective focal length of second lens group | −12.04 |

The aspheric surface (e.g., s1, s4, s5 or s8) may be defined by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{6} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$

where α1=0 for all surfaces, z is a distance from the vertex of lens in the optical axis direction, r is a distance in the direction perpendicular to the optical axis, c is a reciprocal of radius of curvature on vertex of lens, k is a conic constant and α₁ to α₈ are aspheric coefficients. Table 3 shows exemplary constants and coefficients associated with the equation.

TABLE 3

| | k | α2 | α3 | α4 |
|---|---|---|---|---|
| s1 | 0 | −2.6132567 | 73.09426 | −3041.4389 |
| s4 | −13.60203 | −9.6468524 | 126.87827 | −1731.2702 |
| s5 | −49.9946 | 4.1097678 | −64.356174 | 596.94837 |
| s8 | 1.095574 | 1.859126 | −19.888752 | 133.55797 |

| | α5 | α6 | α7 | α8 |
|---|---|---|---|---|
| s1 | 37217.507 | 1144.2817 | −3587.0147 | 228907.05 |
| s4 | 12969.31 | 2396.5052 | −737768.44 | 3417732.6 |
| s5 | −1981.0921 | −11973.786 | 115195.88 | −252363.83 |
| s8 | −398.74397 | −480.14211 | 5863.3082 | −9972.8141 |

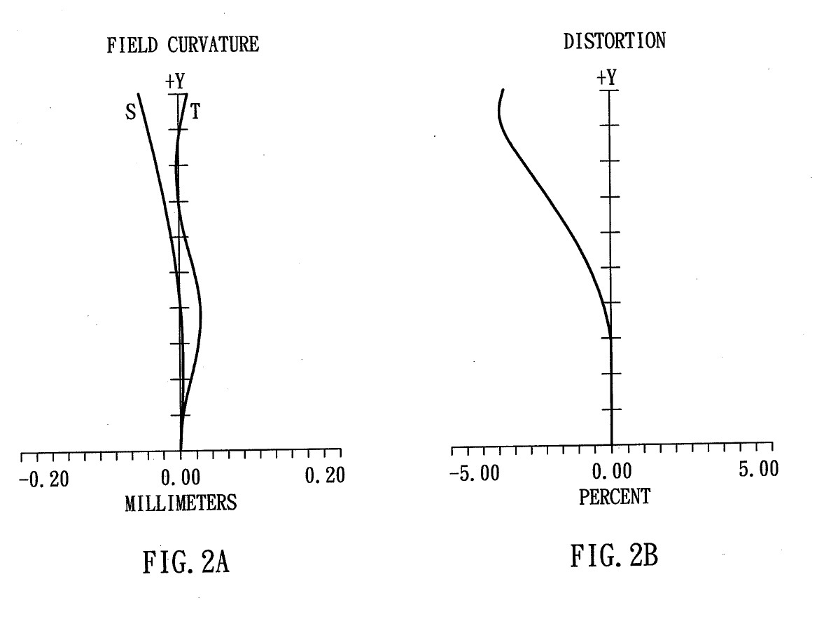

FIG. 2A and FIG. 2B show some performances of the imaging optical device according to the first embodiment. Specifically, FIG. 2A shows field curvature and FIG. 2B shows distortion.

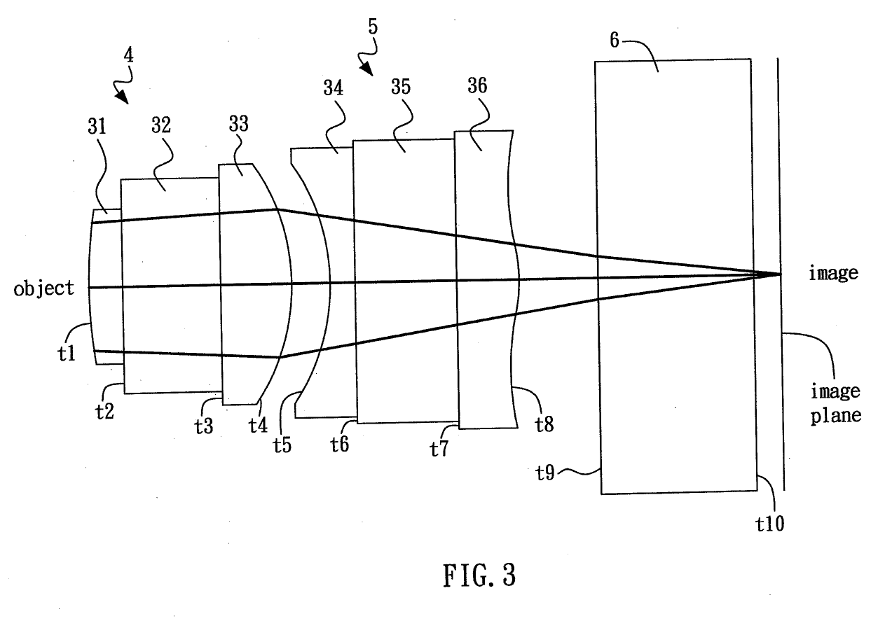

FIG. 3 shows a lens arrangement of a wafer-level imaging optical device according to a second embodiment of the present invention.

In the drawing, the left side of the imaging optical device faces an object, and the right side of the imaging optical device faces an image (or an image plane). In the second embodiment, the imaging optical device includes two lens groups: a first lens group 4 and a second lens group 5 in the order from the object side to the image side. The first lens group 4 acts as a positive lens having a positive refractive power, and the second lens group 5 acts as a negative lens having a negative refractive power. Specifically, the first lens group 4 includes at least three lenses: a first lens 31, a second lens 32 and a third lens 33 in the order from the object side to the image side. The first lens 31 has a convex object-side surface t1. The first lens 31 has an image-side surface t2 in substantially contact with an object-side surface t2 of the second lens 32. The second lens 32 has an image-side surface t3 in substantially contact with an object-side surface t3 of the third lens 33. The third lens 33 has a convex image-side surface t4. In the exemplary embodiment, the surface t2 (i.e., the image-side surface of the first lens 31 and the object-side surface of the second lens 32) may, but not limited to, be planar. The surface t3 (i.e., the image-side surface of the second lens 32 and the object-side surface of the third lens 33) may, but not limited to, be planar.

The second lens group 5 includes at least three lenses: a fourth lens 34, a fifth lens 35 and a sixth lens 36 in the order from the object side to the image side. The fourth lens 34 has a concave object-side surface t5. The fourth lens 34 has an image-side surface t6 in substantially contact with an object-side surface t6 of the fifth lens 35. The fifth lens 35 has an image-side surface t7 in substantially contact with an object-side surface t7 of the sixth lens 36. The sixth lens 36 has a convex image-side surface t8. In the exemplary embodiment, the surface t6 (i.e., the image-side surface of the fourth lens 34 and the object-side surface of the fifth lens 35) may, but not limited to, be planar. The surface t7 (i.e., the image-side surface of the fifth lens 35 and the object-side surface of the sixth lens 36) may, but not limited to, be planar.

The imaging optical device may optionally include a cover glass 6 for an image sensor such as a charge-coupled device (CCD) or complementary metal-oxide-semiconductor image sensor (CIS). The cover glass 6 has, for example, a planar object-side surface t9 and a planar image-side surface t10.

According to one aspect of the present embodiment, with respect to each lens group 4 or 5, the refraction index of material of at least one lens is substantively different from the refraction index of material of other lens in the same lens group.

Table 4 shows some surface data according to the second embodiment, where the thickness and the radius may be unitless or in the unit, for example, of millimeter (mm).

TABLE 4

| | | | Material |
|---|---|---|---|
| | | | nd: refraction index |
| Surface | Radius | Thickness | νd: dispersion index |
| t1 | 2.628 | 0.0639 | nd = 1.52, νd = 50 |
| t2 | Infinity | 0.2515 | nd = 1.51, νd = 70 |
| t3 | Infinity | 0.2149 | nd = 1.52, νd = 50 |
| t4 | −0.265 | 0.1354 | |
| t5 | −0.283 | 0.0713 | nd = 1.52, νd = 50 |
| t6 | Infinity | 0.2515 | nd = 1.51, νd = 70 |
| t7 | Infinity | 0.1382 | nd = 1.52, νd = 50 |
| t8 | −1.223 | 0.1 | |
| t9 | Infinity | 0.4 | nd = 1.5168, νd = 64.17 |
| t10 | Infinity | 0.077 | |

Table 5 shows some optical data according to the second embodiment.

TABLE 5

| | |
|---|---|
| F number (focal ratio) | 2.8 |
| Effective focal length | 1 |
| Field of view (FOV) | 60 degree |
| Effective focal length of first lens group | 0.49 |
| Effective focal length of second lens group | −0.85 |

The aspheric surface (e.g., t1, t4, t5 or t8) may be defined by the following equation:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$

where α1=0 for all surfaces, z is a distance from the vertex of lens in the optical axis direction, r is a distance in the direction perpendicular to the optical axis, c is a reciprocal of radius of curvature on vertex of lens, k is a conic constant and α₁ to α₈ are aspheric coefficients. Table 6 shows exemplary constants and coefficients associated with the equation.

TABLE 6

| | k | α2 | α3 | α4 |
|---|---|---|---|---|
| t1 | −31.60766 | −4.762182 | 142.92806 | −5026.7395 |
| t4 | −6.540471 | −24.743838 | 601.1817 | −9550.0428 |
| t5 | −1.535117 | 15.340242 | −247.87977 | 2421.9181 |
| t8 | 2.965206 | 5.7951023 | −30.400249 | 114.99385 |
| | α5 | α6 | α7 | α8 |
| t1 | 50330.12 | 23.154433 | −1507.0367 | 286.4907 |
| t4 | 56336.211 | 493979.31 | −9129582.1 | 37986439 |
| t5 | −13831.562 | 9674.4212 | 291160.63 | −766184.37 |
| t8 | −402.756 | 1035.8549 | 131.372 | −4398.7019 |

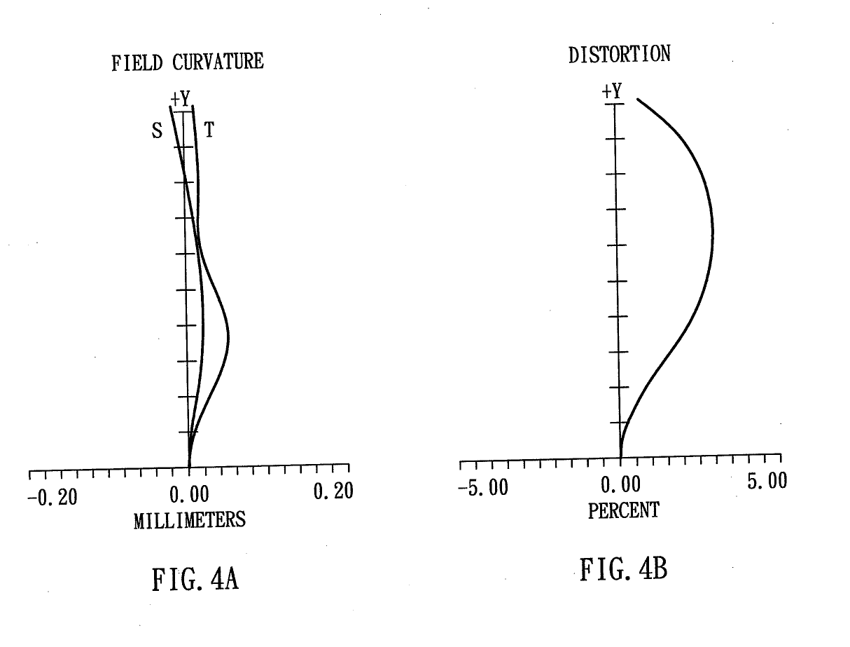

FIG. 4A and FIG. 4B show some performances of the imaging optical device according to the second embodiment. Specifically, FIG. 4A shows field curvature and FIG. 4B shows distortion.

Although specific embodiments have been illustrated and described, it will be appreciated by those skilled in the art that various modifications may be made without departing from the scope of the present invention, which is intended to be limited solely by the appended claims.

What is claimed is:

1. An imaging optical device, comprising:
a first lens group having a positive refractive power, the first lens group including at least a first lens, a second lens and a third lens in an order from an object side to an image side, wherein the first lens has an image-side surface in substantially contact with an object-side surface of the second lens, the second lens has an image-side surface in substantially contact with an object-side surface of the third lens, and the third lens has a convex image-side surface; and
a second lens group having a negative refractive power, the second lens group including at least a fourth lens, a fifth lens and a sixth lens in an order from the object side to the image side, wherein the fourth lens has an image-side surface in substantially contact with an object-side surface of the fifth lens, and the fifth lens has an image-side surface in substantially contact with an object-side surface of the sixth lens;
wherein the first lens group and the second lens group are disposed in an order from the object side to the image side.

2. The imaging optical device of claim 1, wherein a refraction index of material of at least one lens of the first lens group is substantively different from the refraction index of material of other lens or lenses of the first lens group; and the refraction index of material of at least one lens of the second lens group is substantively different from the refraction index of material of other lens or lenses of the second lens group.

3. The imaging optical device of claim 1, further comprising a cover glass for an image sensor disposed between the second lens group and the image sensor.

4. The imaging optical device of claim 3, wherein the cover glass has a planar object-side surface and a planar image-side surface.

5. The imaging optical device of claim 1, wherein the first lens has a planar image-side surface.

6. The imaging optical device of claim 1, wherein the second lens has a planar image-side surface.

7. The imaging optical device of claim 1, wherein the fourth lens has a planar image-side surface.

8. The imaging optical device of claim 1, wherein the fifth lens has a planar image-side surface.

9. The imaging optical device of claim 1, wherein the first lens has a concave object-side surface.

10. The imaging optical device of claim 1, wherein the fourth lens has a convex object-side surface.

11. The imaging optical device of claim 10, wherein the sixth lens has a concave object-side surface.

12. The imaging optical device of claim 1, wherein the first lens has a convex object-side surface.

13. The imaging optical device of claim 1, wherein the fourth lens has a concave object-side surface.

14. The imaging optical device of claim 13, wherein the sixth lens has a convex object-side surface.

15. The imaging optical device of claim 1, wherein the imaging optical device is a wafer-level imaging optical device.
